(19) United States
(12) Patent Application Publication
(10) Pub. No.: US 2026/0203016 A1
(43) Pub. Date: Jul. 16, 2026

(54) AI ENGINE WITH MULTIPLIER SUPPORTING A SUPERSET OF DATA TYPES

(71) Applicant: XILINX, INC., San Jose, CA (US)

(72) Inventors: Francisco BARAT QUESADA, Erembodegem (BE); Luc DE COSTER, Aalst (BE); Pedro Miguel Parola DUARTE, Skerries (IE); Stephan MUNZ, Dublin (IE)

(21) Appl. No.: 19/020,695

(22) Filed: Jan. 14, 2025

(51) Int. Cl. G06F 7/487; G06F 5/01

(52) U.S. Cl. CPC G06F 7/4876; G06F 5/012

(57) ABSTRACT

Embodiments herein describe an artificial intelligence (AI) engine including a register file and a multiplier configured to support a superset of a data type. The register file stores multiple variants of the data type. The AI engine includes logic to expand multiplication operations performed by the multiplier. The data type is a floating-point data type, where the superset of the data type includes a maximum value for a mantissa and a maximum value for an exponent.

### TECHNICAL FIELD

Examples of the present disclosure generally relate to artificial intelligence (AI) engines, and, in particular, to an AI engine with a multiplier supporting a superset of data types.

### BACKGROUND

Data types play a significant role in computing systems, particularly in artificial intelligence (AI) and machine learning (ML) applications, where the choice of data type impacts both precision and efficiency. Commonly used data types, such as integers and floating-point numbers, vary in bit-width and structure, with floating-point formats like FP16, FP8, and bfloat16 gaining prominence for their ability to balance accuracy and resource utilization. The proliferation of data types, however, introduces challenges for hardware architectures, particularly in arithmetic operations like multiplication.

Multipliers, key components in processors and AI engines, perform multiplication operations for specific data types. Traditional designs often dedicate separate multipliers for each data type or bit-width, ensuring compatibility but at the cost of increased silicon area, power consumption, and design complexity. This redundancy becomes problematic as new or specialized data types emerge, necessitating additional hardware and limiting scalability.

### SUMMARY

One example described herein is an artificial intelligence (AI) engine including a register file and a multiplier configured to support a superset of a data type. The register file is configured to store multiple variants of the data type. The AI engine includes logic to expand multiplication operations performed by the multiplier. The data type is a floating-point data type, where the superset of the data type includes a maximum value for a mantissa and a maximum value for an exponent.

One example described herein is a method including storing multiple variants of a data type in a register file of an artificial intelligence (AI) engine and using a multiplier to support a superset of the data type. The AI engine includes logic to expand multiplication operations performed by the multiplier. The data type is a floating-point data type, where the superset of the data type includes a maximum value for a mantissa and a maximum value for an exponent.

One example described herein is a processor including one or more artificial intelligence (AI) engines, each AI engine including a register file and a multiplier configured to support a superset of a data type. The processor may be a graphics processing unit (GPU).

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A illustrates a first data type having two variants, according to an example.

FIG. 1B illustrates a second data type having two variants, according to an example.

FIG. 2A illustrates a multiplier that supports a superset of a first data type, according to an example.

FIG. 2B illustrates a multiplier that supports a superset of a second data type, according to an example.

FIG. 2C illustrates a method for using internal logic to expand the multiplication to be performed by the multiplier, according to an example.

FIG. 3 is a block diagram of an accelerator unit (AU) configured to execute workloads for applications running on a processing system, according to an example.

FIG. 4 illustrates a method for implementing a multiplier that supports a superset of data types, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the examples herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

An AI engine core is a specialized processing unit used to accelerate artificial intelligence (AI) and machine learning (ML) tasks. These AI engine cores are optimized for the computational requirements of AI workloads, which often involve extensive mathematical operations, large datasets, and high parallelism. AI engine cores feature architectures tailored to handle AI workloads. This may include optimized instruction sets, data paths, and memory hierarchies that facilitate efficient processing of matrix and vector operations found in neural networks. AI engine cores are used to perform many calculations simultaneously, leveraging data parallelism inherent in AI algorithms.

AI engine cores include multipliers. A multiplier is a digital circuit or device used to perform multiplication operations on numerical values, usually in binary form. A multiplier is a fundamental component in various computing systems, including processors, digital signal processors (DSPs), graphics processing units (GPUs), and AI accelerators. A multiplier takes two input values (operands) and produces a single output value that is the product of those operands.

Data types define the kind of data that can be stored and manipulated within a computer system. Data types specify the possible values a variable can hold, the operations that can be performed on these values, and the way the values are stored in memory. Different data types play a role in the performance and accuracy of artificial AI/ML models, particularly on specialized hardware like GPUs or AI accelerators. For example, FP32 (32-bit floating-point) is used for training deep learning models because of its high precision. FP16 (16-bit floating-point) is used in AI inference for faster computation with lower memory usage, though with slightly reduced precision.

Floating-Point (FP) data types are used to represent real numbers, including fractions and decimals, in a way that supports a wide range of values. These data types are useful for scientific calculations, graphics, and AI/ML applications where precision and the ability to handle large or small numbers are valuable. Floating-point numbers are stored in scientific notation, represented as a sign (positive or negative), mantissa (or significand), and an exponent. This allows them to cover a wide range of values, from very small to very large. The precision of a floating-point data type refers to how accurately it can represent numbers. Higher precision allows for more significant digits, improving accuracy but also increasing memory usage and computation time.

FP arithmetic is a cornerstone of modern computing, especially in AI and ML workloads, where efficient data representation is important. Recently, FP8 has emerged as a promising data type due to its ability to balance precision and efficiency, making it ideal for AI applications. This data type will be described below for illustrative purposes only. However, there are two distinct variants of FP8, that is, E4M3 (4 exponent bits and 3 mantissa bits) and E5M2 (5 exponent bits and 2 mantissa bits), where each is optimized for specific computational scenarios. While this flexibility is beneficial for different tasks, it introduces challenges in hardware design, particularly in the AI engine.

In conventional AI engines, dedicated multipliers are employed to perform arithmetic operations for each, e.g., FP8 variant. The multipliers can perform arithmetic operations for any data type (e.g., FP16, float 16, etc.). These multipliers are specialized to handle the unique exponent and mantissa configurations of E4M3 and E5M2 (for the FP8 data type). As a result, the hardware includes separate multipliers for each variant, effectively duplicating resources. This approach, while straightforward, leads to inefficiencies in terms of silicon area, power consumption, and design complexity. The duplication not only increases the cost of hardware but also constrains scalability as new data types or variants are introduced.

The inefficiency becomes particularly evident in scenarios where only one FP8 variant is predominantly used. For example, training tasks might favor E4M3 for its broader dynamic range, while inference tasks might prioritize E5M2 for its enhanced precision. In such cases, the unused multiplier contributes to wasted resources, reducing the overall utility of the AI engine. Additionally, this architecture creates challenges in managing workload distribution and utilization within the AI engine.

In view of such challenges, the examples present architectures that unify the handling of, e.g., FP8 variants without using separate multipliers for each type (or any other data types). By designing a versatile multiplier capable of dynamically adapting to the specific configuration of E4M3 or E5M2 (for the FP8 data type), it is possible to achieve significant gains in efficiency and flexibility. Such a solution would not only reduce hardware redundancy but also future-proof the AI engine for emerging data types. The examples thus present a unified multiplier architecture for FP8 variants or superset multiplier, enabling efficient computation without the need for duplicate hardware. The unified multiplier architecture can be applied to bfloat16 and FP16 variants. The unified multiplier architecture can be applied to any data types having any number of variants. The examples are not limited to any type of data type. The design uses dynamic configuration and shared arithmetic units to handle E4M3 and E5M2 (for the FP8 data type) seamlessly, optimizing resource utilization while maintaining high performance. This approach demonstrates how reducing multiplier redundancy can lead to a more efficient and scalable AI engine, capable of meeting the growing demands of modern AI workloads.

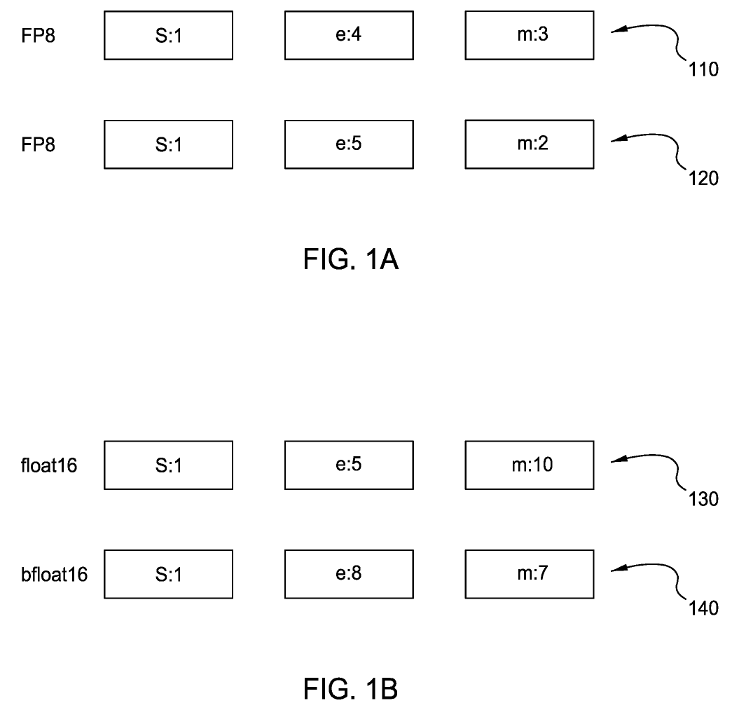

FIG. 1A illustrates a first data type having two variants, according to an example.

The FP8 has emerged as a promising data type due to its ability to balance precision and efficiency, making it ideal for AI applications. However, there are two distinct variants of FP8, that is, E4M3 (4 exponent bits and 3 mantissa bits) and E5M2 (5 exponent bits and2 mantissa bits). As such, the FP8 data type includes a first variant 110 and a second variant 120. The first variant 110 may be referred to as E4M3 and the second variant 120 may be referred to as E5M2. The first variant 110 includes a sign (S:1), a mantissa (M:3), and an exponent (E:4). The second variant 120 includes a sign (S:1), a mantissa (M:2), and an exponent (E:5). In conventional systems, the first variant 110 has a first multiplier and the second variant 120 has a second multiplier. Thus, each variant is associated with a respective multiplier. However, in the examples, the first variant 110 and the second variant 120 are associated with a single multiplier, which is a superset of two variants, as described in detail below. The FP8 data type is used as an illustrative example. The examples may apply to any data types.

FIG. 1B illustrates a second data type having two variants, according to an example.

The bfloat16 is another data type used for AI applications. However, there can be several distinct variants of bfloat16, that is, E5M10 (1 sign bit, 5 exponent bits and 10 mantissa bits) and E8M7 (1 sign bit, 7 exponent bits and 8 mantissa bits). As such, the bfloat16 data type includes a first variant 130 and a second variant 140. The first variant 130 may be referred to as E5M10 and the second variant 140 may be referred to as E8M7. E8M7 may be referred to as a brain floating point or bfloat16. The first variant 130 includes a sign (S:1), a mantissa (M:5), and an exponent (E:10). The second variant 140 includes a sign (S:1), a mantissa (M:8), and an exponent (E:7). In conventional systems, the first variant 130 has a first multiplier and the second variant 140 has a second multiplier. Thus, each variant is associated with a respective multiplier. However, in the examples, the first variant 130 and the second variant 140 are associated with a single multiplier, which is a superset of two variants, as described in detail below. The bfloat16 data type is used as an illustrative example. The examples may apply to any data types.

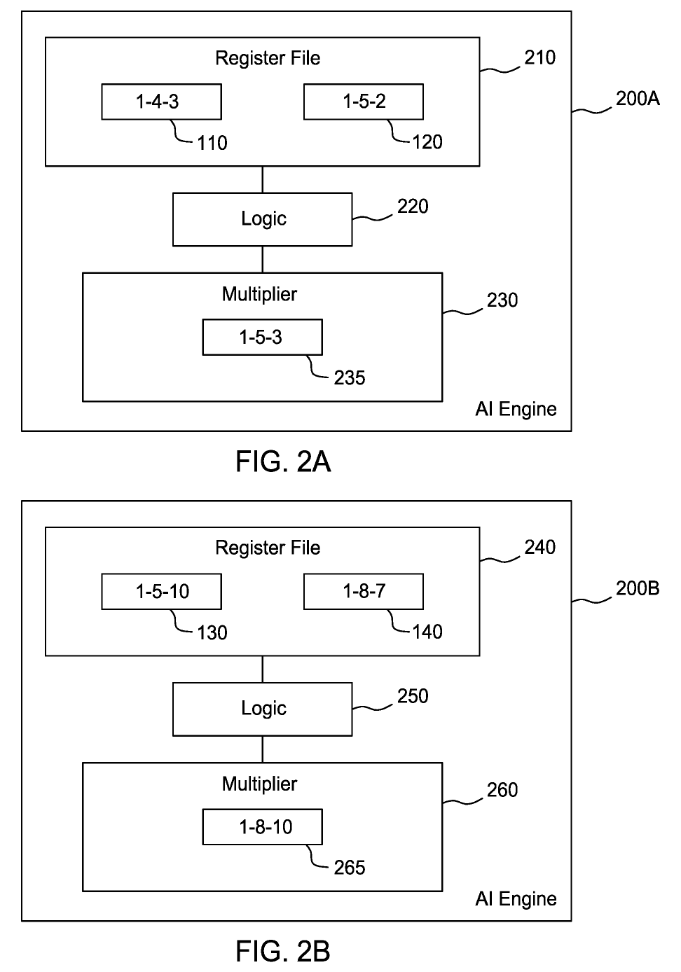

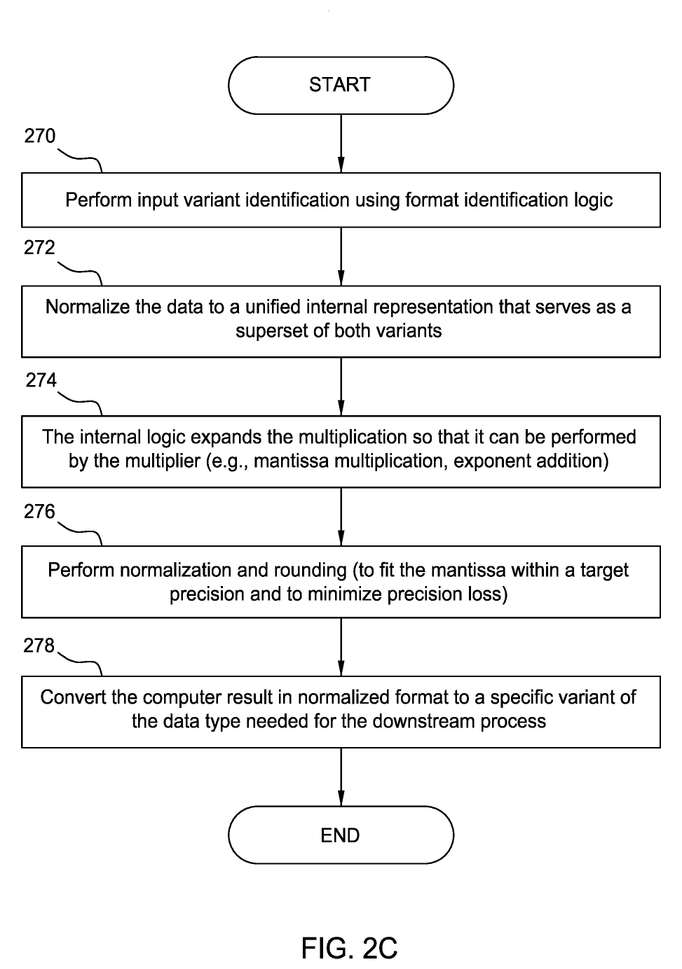

FIG. 2A illustrates a multiplier that supports a superset of a first data type, according to an example.

The AI engine 200A includes a register file 210. In one example, the register file 210 stores the first variant 110 and the second variant 120 of the data type FP8. The internal logic 220 expands the multiplication so that it can be performed by the multiplier 230. The multiplier 230 is a single multiplier that can handle both variants of the data type FP8. The multiplier 230 includes a superset variant 235. The superset variant 235 can be represented as E5M3. In other words, the superset variant 235 includes a sign (S:1), a mantissa (M:5), and an exponent (E:3). Expanding the multiplication refers to adapting the inputs from different variants of the data type into a unified format that can be processed by the multiplier. This ensures that the inputs are compatible in terms of precision, and it may involve modifications to the mantissas, exponents, and even the overall data encoding. For example, if two FP8 variants have different mantissa sizes, the mantissas are expanded to match the precision of the superset format. Similarly, the exponents may have different biases, which are adjusted to align them within a shared scale. By converting the inputs to a superset format, the multiplier can handle them uniformly, regardless of their original differences. This expansion of the multiplication ensures that the hardware does not need separate multiplication logic for each variant. The expanded multiplication also includes handling the intermediate results of the mantissa multiplication. Since multiplying the expanded mantissas produces a result larger than the original precision, normalization and rounding are applied to fit the result back into the superset format. Thus, the expansion of the multiplication enables the multiplier to seamlessly process inputs from different data type variants with a unified operational framework.

The register file 210 in the AI engine 200A is a small, high-speed storage area that holds a set of registers used for temporarily storing data during computation. The register file 210 stores intermediate values and operands that are actively used during computations, allowing for quick access by the processing units. The register file 210 can accommodate various data types (e.g., integers, floating-point numbers, fixed-point representations) used in AI computations. Many AI engine cores support mixed precision to optimize performance and resource utilization.

The internal logic 220 operates at a single precision level, avoiding format-specific multipliers. Smaller formats can be accommodated by expanding the inputs and truncating the outputs. The internal logic 220 supports scenarios where operands are in different formats. Stated differently, the internal logic 220 supports different variants of each data type. The internal logic can accommodate the expansion of the inputs. Each input operand is expanded to match the superset format. The expansion involves exponent alignment, mantissa alignment, and sign alignment. For the exponent alignment, smaller exponents are extended to match the superset’s range, for mantissa alignment, the smaller mantissas are padded to the largest size, and for the sign alignment the sign bit remains unchanged since it is common across all variants of the format.

When a multiplier handles a superset of two variants of a data type, the internal logic 220 performs, e.g., normalization and conversion of the data to a unified internal format that the multiplier can process. The first step may involve identifying the specific variant of the data type. A format detection unit may determine the variant of, e.g., the FP8 data type. Once the variant is identified, the data may be converted to a common internal format that represents the superset of the two variants. This may involve exponent alignment and mantissa extension. Exponent alignment involves adjusting the exponent based on the variant’s bias value to match the unified format. Mantissa extension involves normalizing and extending the mantissa. Once the inputs are in the unified format, the multiplier processes the data as if it were a single unified data type. For example, the mantissas are multiplied while the exponents are added and the resulting product is normalized to meet the FP8 format’s constraints. If the result exceeds the mantissa’s precision, a rounding scheme may be employed. After the multiplication, the output may need to be converted back into the specific variant of FP8 needed for downstream processing. FIG. 2C below describes the operations of the internal logic 220 and the multiplier in more detail.

The general structure for FP8 formats can be:

E4M3 (exponent 4 bits, mantissa 3 bits), where this representation uses 4 bits for the exponent and 3 bits for the mantissa. This allows for a smaller range but may offer higher precision for small values within that range.

E5M2 (exponent 5 bits, mantissa 2 bits), where this format increases the range (since the exponent uses 5 bits) but reduces the precision (since the mantissa uses only 2 bits).

E5M3 (exponent 5 bits, mantissa 3 bits), where this is a superset of the previous two formats. It provides the same range as E5M2 but with slightly higher precision due to the additional bit in the mantissa.

The E5M3 format is a superset of the E5M2 and E4M3 formats, meaning it can represent all values that those formats can. This superset allows the multiplier 230 to handle cases where the exponent and mantissa need to be expanded or contracted. The multiplier 230 itself only operates on E5M3. The multiplier converts incoming data from the source format to E5M3. Also, the output format of the multiplier need not be one of the input formats. For example, inputs to the multiplier can be in reduced precision formats such as FP16 or custom formats like E8M7. The output may generally be in FP32 format, which provides for higher precision.

FIG. 2B illustrates a multiplier that supports a superset of a second data type, according to an example.

The AI engine 200B includes a register file 240. The register file 240 stores the first variant 130 and the second variant 140 of the data type bfloat16. The logic 250 expands the multiplication so that it can be performed by the multiplier 260. The logic 250 is the same as the logic 220 described above. The multiplier 260 is a single multiplier that can handle both variants of the data type bfloat16. The multiplier 260 includes a superset variant 265. The superset variant 265 can be represented as E8M10. In other words, the superset variant 265 includes a sign (S:1), a mantissa (M:8), and an exponent (E:10).

The general structure for bfloat formats can be:

E5M10, which includes a 5-bit exponent that allows for smaller range and a 10-bit mantissa that provides higher precision within the range.

E8M7, which includes an 8-bit exponent that extends the range significantly and a 7-bit mantissa that reduces precision compared to E5M10.

E7M10 is a superset including a 7-bit exponent that combines the extended range of E8M7 and a 10-bit mantissa that retains the high precision of E5M10.

The single multiplier supporting these bfloat16 variants is flexible in handling the differences in exponent size, mantissa size, normalization and rounding, and superset compatibility. The single multiplier can adjust for varying ranges due to the different number of exponent bits and can ensure that precision is maintained or properly rounded when moving between formats. The single multiplier can further normalize the result and round appropriately to fit the target format and ensure compatibility with the superset (E8M10), accommodating the largest possible range and precision.

FIG. 2C illustrates a method for using internal logic to expand the multiplication to be performed by the multiplier, according to an example.

At 270, input variant identification is performed using format identification logic. The multiplier first identifies which variant of the data type is provided. Each format has unique characteristics, such as the size of the exponent and mantissa fields and specific bias values for the exponent. The format identification logic inspects the incoming bit patterns to classify the inputs.

At 272, the data is normalized to a unified internal representation that serves as a superset of both variants. This ensures the multiplier can work on a single, consistent data format. Exponent alignment and mantissa extension operations may take place. The exponent may be adjusted based on the input variant’s bias value and the mantissa may be expanded to the largest bit-width among the variants by adding zeroes or shifting the significant bits. This guarantees compatibility during multiplication.

At 274, the internal logic expands the multiplication so that it can be performed by the multiplier (e.g., mantissa multiplication, exponent addition). The mantissas are multiplied directly and the exponents of the two inputs are added together, adjusted for any bias offsets introduced during normalization.

At 276, normalization and rounding is performed to fit the mantissa within a target precision and to minimize precision loss. This may involve adjusting the result so that the most significant bit is in the proper position. Also, common rounding modes (e.g., truncation) may be employed depending on the hardware design.

At 278, the computer result in normalized format is converted to a specific variant of the data type needed for the downstream process. For example, the exponent is adjusted to match the output variant’s bias. The mantissa may be truncated to fit the target variant’s precision. The final result may be re-encoded into the output format to ensure compatibility with the original data type.

Therefore, the internal logic enables the multiplier to process a superset of data type variants by converting all inputs into a unified internal format, performing the multiplication using generalized arithmetic, and then mapping the results back to the original format. The multiplier can thus maintain flexibility, consistency, and compatibility across multiple data representations, while using efficient hardware for computation.

Multipliers are fundamental in AI and computing. Multiplication is a fundamental operation in many computational tasks, such as convolution, matrix operations, and polynomial evaluations. In AI and ML, multipliers are heavily used for matrix-matrix and matrix-vector multiplications in tasks like neural network training and inference. Hardware multipliers are orders of magnitude faster and more energy-efficient than performing multiplication in software using basic arithmetic operations. Multipliers are used in multiply-accumulate (MAC) units, which are valuable for performing tensor operations in AI workloads. As such, a multiplier is an indispensable building block in digital systems and AI engines, enabling fast and efficient arithmetic operations. Multiplier design and implementation significantly influences the performance, power efficiency, and versatility of modern processors and AI accelerators (e.g., GPUs). Thus, providing a superset multiplier (e.g., the multiplier 230) is advantageous in that it can process all formats and variants, reducing hardware overhead, as the superset multiplier can accommodate operands of different precisions. Also, the superset multiplier enables the use of inputs with smaller formats with additional padding logic, minimizing idle hardware. Moreover, power usage is optimized by consolidating functionality into a single unit. Further, superset multipliers are beneficial in environments like AI accelerators (e.g., GPUs), where workloads involve computations at varying precisions. This ensures seamless transition between different precision levels without stalling pipelines.

Referring to FIG. 2A for sake of brevity, the AI engine 200A capable of supporting a superset of data types is employed to handle a wide variety of data representations, enabling greater flexibility, efficiency, and accuracy across diverse applications. AI engine 200B provides similar capabilities.

The AI engine 200A supporting a superset of data types bridges the gap between flexibility and performance. The AI engine 200A allows developers to tailor precision and representation to their specific use cases, optimizing computational efficiency and expanding the range of supported AI and ML workloads.

The AI engine 200A capable of using a single, versatile multiplier to support multiple data types eliminates the need for dedicated hardware for each type or variant. Instead, this approach uses configurable arithmetic units that adapt to a wide range of data formats (or variants), offering flexibility, efficiency, and scalability in AI computations.

The advantages of using a superset multiplier (e.g., the multiplier 230) include reduced hardware complexity, flexibility, power efficiency, and improved throughput. The superset multiplier eliminates the need for separate multipliers for each data type (INT8, FP8, FP16, etc.). A single hardware unit handles all supported types, reducing silicon area and design complexity.

The superset multiplier supports a broad spectrum of data types, including emerging and custom formats, without involving hardware changes, and is adaptable to application-specific requirements by reprogramming the control logic. The superset multiplier dynamically allocates only the necessary resources for the precision needed, reducing unnecessary switching and power consumption, and enables selective deactivation of unused bit-slice units when operating on lower precision types. The superset multiplier can perform multiple operations in parallel for smaller data types.

Reducing the number of multipliers in an AI engine core can yield several benefits and advantages, particularly in terms of efficiency, cost, and performance optimization. The benefits can include area and cost savings, power efficiency, resource optimization, simplified design and integration, and enhanced scalability and flexibility.

Multipliers are among the most area-consuming components in integrated circuits. By reducing the number of multipliers, the overall silicon area needed for the AI engine core can be minimized. This leads to a smaller chip size, which can reduce production costs. A smaller die size translates to lower manufacturing costs per chip. This is beneficial for mass-produced devices, where saving on production costs can lead to significant profit margins.

Multipliers, especially those handling floating-point operations, can consume a significant amount of power. Fewer multipliers lead to lower dynamic and static power consumption, which is beneficial for mobile and edge devices where battery life is a concern. With fewer multipliers, the thermal output of the AI engine core can be reduced, allowing for more efficient cooling solutions and potentially extending the lifespan of the components due to lower operating temperatures.

By reducing the number of multipliers, designers can allocate more resources to other functional units in the AI engine core, such as memory management, data buffering, or additional processing units that may further enhance overall performance. Reducing the number of multipliers can simplify the overall architecture of the AI engine core, making it easier to design, validate, and integrate. A simpler design often leads to fewer potential points of failure, improving reliability. With fewer multipliers, the data flow within the AI engine core can be optimized to minimize latency and improve throughput, as fewer resources are competing for access to shared memory or data buses.

A design that employs fewer multipliers can be more modular, allowing for easier updates or modifications. This can be beneficial as AI models evolve and demand different types of operations or increased throughput. With fewer multipliers, the AI engine core can prioritize and adapt to specific workloads, potentially using more advanced optimization techniques to maximize performance based on the types of AI/ML models being executed.

Therefore, while multipliers are beneficial for high-performance computations in AI/ML applications, strategically reducing their number in an AI engine core can lead to significant advantages in terms of area and cost savings, power efficiency, resource optimization, design simplicity, and flexibility. By using innovative design strategies such as mixed-precision computing and shared resources, designers can achieve a balanced architecture that meets the demanding requirements of modern AI applications while maintaining high performance and efficiency.

A MAC unit is a fundamental building block in the AI engine 200A. The MAC unit performs multiply-accumulate operations for matrix multiplication, convolutions, and dot products. AI engines may include hundreds or thousands of MAC units working in parallel to achieve high throughput. This allows the AI engine 200A to execute a massive amount of computations needed by AI workloads. AI engines use arithmetic (e.g., FP8, FP16, bfloat16, etc.) to increase the efficiency of MAC units.

Using a single MAC datapath to support multiple FP data types is an efficient architectural design choice in modern processors and AI accelerators (e.g., GPUs). This approach helps optimize resource utilization while maintaining high performance for various computations, especially in applications like AI and ML. As noted, a MAC unit is a fundamental building block in many AI applications. The MAC unit performs two primary operations, that is, multiplication and accumulation. Multiplication involves multiplying two numbers (operands) and accumulation involves adding the product to an existing value (often an accumulator). The output of a MAC operation is used in various applications, such as calculating weighted sums in neural networks. Floating-point numbers are used to represent real numbers in computing. Floating-point numbers provide a way to express a wide range of values (including very large or very small numbers) with a finite number of digits. Different floating-point formats include, e.g., FP32, FP16, FP8, blfoat16, etc.

Utilizing a single MAC datapath for multiple FP data types reduces the overall hardware complexity and area needed on the chip. Instead of having separate MAC units for each data type, a shared unit can adapt to process different formats, thus saving space and power. A single MAC unit can be configured to operate with different precision formats as needed. This allows for dynamic adaptability in applications that may switch between different FP data types based on workload requirements, such as training versus inference in ML models.

The examples are not limited to any particular data type. The data types FP8 and bfloat16 were presented for illustrative purposes only. Supporting all data types is beneficial for architectures handling diverse computational workloads. By creating a superset for any data type, the present architecture becomes versatile. This flexible approach allows the present architecture to handle various types of data without being constrained by a fixed data type or format.

Moreover, conversion between a standard data type and a common data type can be performed just before the multiplication or when writing the data to the register file, before it is passed to the multiplier. When data type conversion happens just before the multiplication, it means that the input data is first converted from the standard format (e.g., FP32, INT8) into a common format (e.g., FP16, FP8) right before it enters the multiplier for computation. This process ensures consistency and real-time adjustment. The data passed to the multiplier is standardized to a common format, which simplifies the multiplication process, especially if the multiplier is optimized for a specific data type (e.g., FP16). Conversion is performed on the fly, allowing the system to work with different data types dynamically. For example, data from various sources may be in different formats, but before performing the multiplication, the system ensures that all inputs are converted to a uniform type, like FP16.

Alternatively, conversion can take place when the data is written to the register file before being passed to the multiplier. The register file acts as a temporary storage that holds operands and intermediate results during computation. In this case, for pre-processing, the data is converted into the common format before being written into the register file. This approach ensures that when the data is accessed from the register file for the multiplication, it is already in the required common format. By converting the data before storing it in the register file, the conversion overhead is separated from the computation phase. The multiplier can directly operate on the data without needing to perform the conversion each time. This can be useful when the same data is reused multiple times, as it avoids redundant conversions. The trade-off is that this approach may involve extra steps in the register file management, as it needs to store and manage both the original and the converted data formats in some cases.

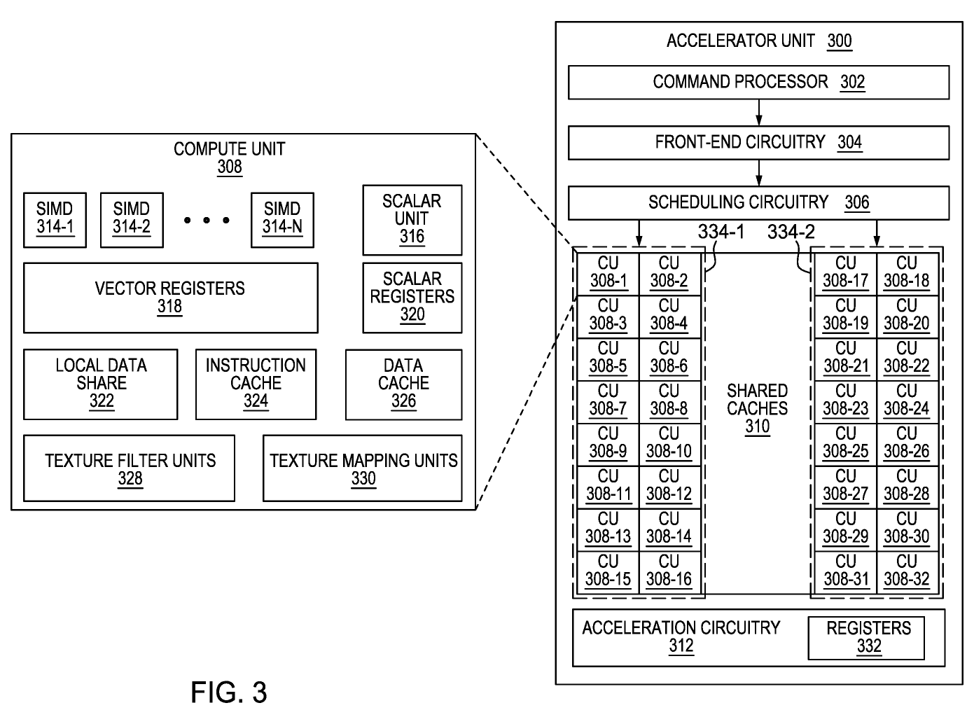

FIG. 3 is a block diagram of an accelerator unit (AU) configured to execute workloads for applications running on a processing system, in accordance with some examples.

FIG. 3 presents an AU 300 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 300. To perform these workgroups, AU 300 includes one or more vector processors, coprocessors, graphics processing units (GPUs), general-purpose GPUs, non-scalar processors, highly parallel processors, artificial intelligence (AI) processors, inference engines, AI engines, AI engine cores, machine-learning processors, or any combination thereof. As an example, AU 300 includes one or more command processors 302, front-end circuitry 304, scheduling circuitry 306, compute units 308, shared caches 310, and acceleration circuitry 312.

A command processor 302 of AU 300 is configured to receive, from the CPU, a command stream indicating one or more workgroups to be executed. As an example, based on a compute application running on the processing system, the command processor 302 receives a command stream indicating workgroups that involve compute operations such as matrix multiplication, addition, subtraction, and the like to be performed. As another example, based on a graphics application running on the processing system, the command processor 302 receives a command stream indicating workgroups that include draw calls for a scene to be rendered. After receiving a command stream, the command processor 302 parses the command stream and issues respective instructions of the indicated workgroups to front-end circuitry 304, scheduling circuitry 306, or both. As an example, based on a command stream from a graphics application, the command processor 302 issues one or more draw calls to front-end circuitry 304 that includes one or more vertex shaders, polygon list builders, and the like. From the instructions issued from the command processor 302, front-end circuitry 304 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 302, front-end circuitry 304 determines a list of primitives to be rendered for a scene. After determining a list of primitives to be rendered for a scene, the front-end circuitry 304 issues one or more draw calls (e.g., a workgroup) associated with the primitives in the list of primitives to scheduling circuitry 306.

Based on the instructions of the workgroups received from a command processor 302, front-end circuitry 304, or both, scheduler circuitry 306 is configured to provide data indicating threads (e.g., operations for these threads) to be executed for these workgroups to one or more compute units 308. Each compute unit 308 is configured to support the concurrent execution of two or more threads of a workgroup. For example, each compute unit 308 is configured to concurrently execute a predetermined number of threads referred to herein as a “wavefront.” Based on the size of the wavefront of a compute unit 308, scheduler circuitry 306 schedules one or more groups of threads of the workgroup, also referred to herein as “waves,” to be executed by the compute unit 308. As an example, scheduler circuitry 306 first updates one or more registers of a compute unit 308 such that the compute unit 308 is configured to execute a first group of waves of the workgroup. After the compute unit 308 has executed the first group of waves, scheduler circuitry 306 updates one or more registers of the compute unit 308 to schedule a second group of waves of the workgroup to be executed by the compute unit 308. To execute these waves, each compute unit is connected to one or more shared caches 310 that each include a volatile memory, non-volatile memory, or both accessible by one or more compute units 308. These shared caches 310, for example, are configured to store data (e.g., register files, values, operands, instructions, variables) used in the execution of one or more waves, data resulting from the performance of one or more waves, or both. Because a shared cache 310 is accessible by two or more compute units 308, a first compute unit 308 is enabled to provide results from the execution of a first wave to a second compute unit 308 executing a second wave. Though the examples presented in FIG. 3 shows AU 300 as including 32 compute units (308-1 to 308-32), in other implementations, AU 300 can include any number of compute units 308.

Each compute unit 308 includes one or more single instruction, multiple data (SIMD) units 314, a scalar unit 316, vector registers 318, scalar registers 320, local data share 322, instruction cache 324, data cache 326, texture filter units 328, texture mapping units 330, or any combination thereof. A SIMD unit 314 (e.g., a vector processor) is configured to concurrently perform multiple instances of the same operation for a wave. For example, a SIMD unit 314 includes two or more lanes each including an arithmetic logic unit (ALU) and each configured to perform the same operation for the threads of a wave. Though the examples presented in FIG. 3 shows a compute unit 308 including three SIMD units (314-1, 314-2, 314-N) representing an N number of SIMD units, in other implementations, a compute unit 308 can include any number of SIMD units 314. Further, as an example, the size of a wavefront supported by AU 300 is based on the number of SIMD units 314 included in each compute unit 308. To determine the operations performed by the SIMD units 314, each compute unit 308 includes vector registers 318 formed from one or more physical registers of AU 300. These vector registers 318 are configured to store data (e.g., operands, values) used by the respective lanes of the SIMD units 314 to perform a corresponding operation for the wave. Additionally, each compute unit 308 includes a scalar unit 316 configured to perform scalar operations for the wave. As an example, the scalar unit 316 includes an ALU configured to perform scalar operations. To support the scalar unit 316, each compute unit 308 includes scalar registers 320 formed from one or more physical registers of accelerator unit 300. These scalar registers 320 store data (e.g., operands, values) used by the scalar unit 316 to perform a corresponding scalar operation for the wave.

Further, each compute unit 308 includes a local data share 322 formed from a volatile memory (e.g., random-access memory) accessible by each SIMD unit 314 and the scalar unit 316 of the compute unit 308. That is to say, the local data share 322 is shared across each wave concurrently executing on the compute unit 308. The local data share 322 is configured to store data resulting from the execution of one or more operations for one or more waves, data (e.g., register files, values, operands, instructions, variables) used in the execution of one or operations for one or more waves, or both. As an example, the local data share 322 is used as a scratch memory to store results necessary for, aiding in, or helpful for the performance of one or more operations by one or more SIMD units 314. The instruction cache 324 of a compute unit 308, for example, includes a volatile memory, non-volatile memory, or both configured to store the instructions to be executed for one or more waves to be executed by the compute unit 308. Further, the data cache 326 of a compute unit 308 includes a volatile memory, non-volatile memory, or both configured to store data (e.g., register files, values, operands, variables) used in the execution of one or more waves by the compute unit 308. The instruction cache 324, data cache 326, shared caches 310, and a system memory, for example, are arranged in a hierarchy based on the respective sizes of the caches. As an example, based on such a cache hierarchy, a compute unit 308 first requests data from a controller of a corresponding data cache 326. Based on the data not being in the data cache 326, the data cache 326 requests the data from a shared cache 310 at the next level of the cache hierarchy. The caches then continue in this way until the data is found in a cache or requested from the system memory, at which point, the data is returned to the compute unit 308. Additionally, each compute unit 308 includes one or more texture mapping units 330 each including circuitry configured to map textures to one or more graphics objects (e.g., groups of primitives) generated by the compute units 308. Further, each compute unit 308 includes one or more texture filter units 328 each having circuitry configured to filter the textures applied to the generated graphics objects. For example, the texture filter units 328 are configured to perform one or more magnification operations, anti-aliasing operations, or both to filter a texture.

Additionally, to help perform instructions for one or more workgroups, AU 300 includes acceleration circuitry 312. Such acceleration circuitry 312 includes hardware (e.g., fixed-function hardware) configured to execute one or more instructions for one or more workgroups. As an example, acceleration circuitry 312 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 306 is configured to update one or more physical registers 332 of AU 300 associated with the hardware. In some cases, AU 300 includes one or more compute units 308 grouped into one or more shader engines 334. Referring to the implementation presented in FIG. 3, for example, AU 300 includes compute units 308-1 to 308-16 grouped in a first shader engine 334-1 and compute units 308-17 to 308-32 grouped in a second shader engine 334-2. Such shader engines 334, for example, are configured to execute one or more workgroups (e.g., one or more compute kernels) for an application and include one or more compute units 308, graphics processing hardware (e.g., primitive assemblers, rasterizers), one or more shared caches 310, render backends, or any combination thereof. Though the example presented in FIG. 3 shows AU 300 as including two shader engines (334-1, 334-2), in other implementations, AU 300 can include any number of shader engines (334-1, 334-2).

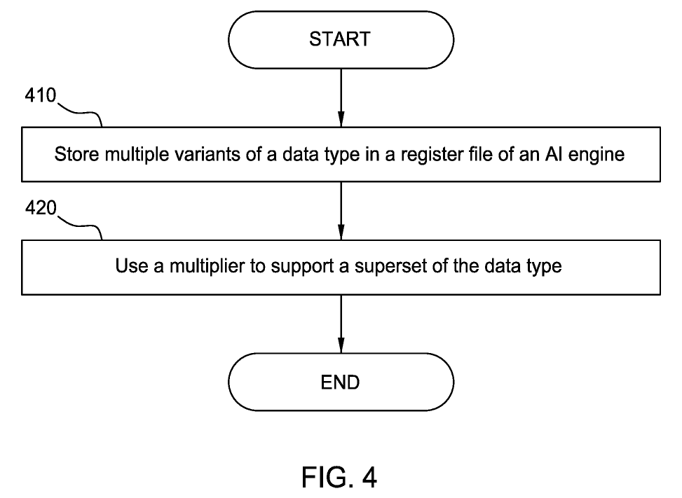

FIG. 4 illustrates a method for implementing a multiplier that supports a superset of data types, according to an example.

At 410, the multiple variants of a data type are stored in a register file of an AI engine. In one example, the register file stores the first variant and the second variant of the data type FP8. In another example, the register file stores the first variant and the second variant of the data type bfloat16. The register file can store variants of any data type. The examples are not limited to any one data type. In one architecture, the register file includes the common format (E5M3), with the conversion to the common format done when writing to the register file. In another architecture, the conversion is done before the multiplier, for every multiplication.

At 420, a multiplier is used to support a superset of the data type. The multiplier is a single multiplier that can handle both variants of the data type FP8 (or data type bfloat16 or any other data type). The multiplier includes a superset variant. The superset variant can be represented as, e.g., E5M3 for the FP8 data type. The superset variant can be represented as, e.g., E8M10 for the bfloat16 data type.

In conclusion, the examples provide for a single multiplier that can support multiple variants of a data type. In one example, the data type is a floating point data type. The single multiplier supports a superset of the data type. The superset includes a maximum value of a mantissa and exponent of the floating point data type. As such, multiple variants of a data type are supported by a single superset multiplier. This results in a reduction of multipliers in the AI engine. Logic in the AI engine expands the multiplication operations so that they can be performed by the single superset multiplier.

A single multiplier (or superset multiplier) that supports different variants of the same data type (such as, e.g., FP8 with E4M3, E5M2, and E5M3) needs to be highly flexible. The single multiplier handles dynamic exponent and mantissa sizes, adapts to different ranges and precision requirements, and ensures proper normalization, rounding, and overflow/underflow management. The E5M3 format being a superset allows for the handling of a wider range of values and higher precision than E4M3 and E5M2 (for the FP8 data type), so the multiplier design is capable of scaling operations to fit within this broader format while still supporting the more compact representations. The examples present a unified multiplier architecture for FP8 variants or superset multiplier, enabling efficient computation without the need for duplicate hardware. The unified multiplier architecture can be applied to bfloat16 and FP16 variants. The unified multiplier architecture can be applied to any data types having any number of variants. The examples are not limited to any type of data type.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An artificial intelligence (AI) engine comprising:
a register file; and
a multiplier configured to support a superset of a data type.

2. The AI engine of claim 1, wherein the register file is configured to store multiple variants of the data type.

3. The AI engine of claim 1, wherein the AI engine includes logic to expand multiplication operations performed by the multiplier.

4. The AI engine of claim 3, wherein the logic is configured to normalize and convert the data type to a unified format configured to be handled by the multiplier.

5. The AI engine of claim 1, wherein the data type is a floating-point data type, and wherein the superset of the data type includes a first data type variant having a first number of mantissa bits and a second data type variant having a second number of mantissa bits different from the first number.

6. The AI engine of claim 5, wherein the superset of the data type includes a maximum value for a mantissa and a maximum value for an exponent.

7. The AI engine of claim 1, wherein the multiplier is part of a multiply-accumulate (MAC) datapath that is configured to support the superset of the data type.

8. A method comprising:
storing multiple variants of a data type in a register file of an artificial intelligence (AI) engine; and
using a multiplier to support a superset of the data type.

9. The method of claim 8, wherein the AI engine includes logic to expand multiplication operations performed by the multiplier.

10. The AI engine of claim 9, wherein the logic is configured to normalize and convert the data type to a unified format configured to be handled by the multiplier.

11. The method of claim 8, wherein the data type is a floating-point data type, and wherein the superset of the data type includes a first data type variant having a first number of mantissa bits and a second data type variant having a second number of mantissa bits different from the first number.

12. The method of claim 11, wherein the superset of the data type includes a maximum value for a mantissa and a maximum value for an exponent.

13. The method of claim 8, wherein the multiplier is part of a multiply-accumulate (MAC) datapath that is configured to support the superset of the data type.

14. A processor comprising:
one or more artificial intelligence (AI) engines, each AI engine including:
a register file; and
a multiplier configured to support a superset of a data type.

15. The processor of claim 14, wherein the processor is a graphics processing unit (GPU).

16. The processor of claim 14, wherein the register file is configured to store multiple variants of the data type.

17. The processor of claim 14, wherein the AI engine includes logic to expand multiplication operations performed by the multiplier and wherein the logic is configured to normalize and convert the data type to a unified format configured to be handled by the multiplier.

18. The processor of claim 14, wherein the data type is a floating-point data type, and wherein the superset of the data type includes a first data type variant having a first number of mantissa bits and a second data type variant having a second number of mantissa bits different from the first number.

19. The processor of claim 18, wherein the superset of the data type includes a maximum value for a mantissa and a maximum value for an exponent.

20. The processor of claim 14, wherein the multiplier is part of a multiply-accumulate (MAC) datapath that is configured to support the superset of the data type.
